(19) United States
(12) Patent Application Publication
(10) Pub. No.: US 2009/0030787 A1
(43) Pub. Date: Jan. 29, 2009

(54) Electronic capture and communication of promotions using a wireless device

(75) Inventors: Barry M. Pon, Millbrae, CA (US); David Lyn Vergeyle, Long Lake, MN (US); David McClanahan, Portland, OR (US)

Correspondence Address: BLAKELY SOKOLOFF TAYLOR & ZAFMAN LLP, 1279 OAKMEAD PARKWAY, SUNNYVALE, CA, 94085-4040, US

(73) Assignee: XperEx Corporation

(21) Appl. No.: 11/880,947

(22) Filed: Jul. 24, 2007

(51) Int. Cl. G06Q 40/00

(52) U.S. Cl. 705/14; 707/104.1

(57) ABSTRACT

Methods and apparatuses to electronically capture and communicate promotions using a cellular device are discussed. An application on a wireless device is activated and a store's identification is sent from the wireless device to a promotion processing unit where targeted promotions are sent from the promotion processing unit to the wireless device and a point of sale in a store corresponding to the store ID in response to receiving the store identification. A user using the wireless device can further capture on-demand promotions and transmit them to the promotion processing unit where the promotion processing unit will associate the user's identification with the on-demand promotions and send the on-demand promotion to the point of sale so the targeted promotions and at least a portion of the on-demand promotions can be redeemed at the point of sale in the store. Other embodiments are described in the disclosure.

### TECHNICAL FIELD

This disclosure relates generally to the electronic capture and communication of promotions, and in particular but not exclusively, relates to the electronic capture and communication of promotions with the use of a wireless device.

### BACKGROUND OF THE INVENTION

Promotions are often displayed in commercial settings, such as in a store. Typically, such promotions may appear on printed signage proximate to the goods to which the particular promotion is associated. For example, printed coupon dispensers, offers to enter a contest, or offers for samples etc. may be placed in an aisle near the physical location of the goods in which the promotions are associated. A consumer is then required to physically take the printed coupon, or offers to enter a contest or offers for samples etc. and take action. For instance, the consumer has to take the printed coupon along with the associated goods to the checkout or point-of-sale (POS) and present both prior to completing the sale. Similarly, the consumer has to mail the offer to enter a contest or mail the offer for samples. One major disadvantage with this system is that the consumer has to retain the physical promotion for each item while shopping, which may be cumbersome to a shopper having many items. Furthermore, the consumer is required to take separate actions to gain the benefits of each promotion. This in turn consumes time and discourages consumers to participate in promotions.

Product manufacturers and services providers, advertisers and promoters are often concerned with attracting, understanding and maintaining consumer interest in their products and services. While efforts to attract consumer attention through attractive visual and graphic displays have been used, they are not specifically targeted or tailored to individual consumers. Compounded with the hectic and busy lives of modern day individuals, consumers are often overexposed to numerous promotional materials when they enter a store and thus become insensitive or complacent to promotions. Therefore, there is a desire to gain the consumers' attention when promotions are presented to them and also to reduce the efforts required from consumers to take advantage of the promotions presented.

Wireless devices, such as cellular phones, personal digital assistants etc. are becoming an indispensable accessory to individual consumers for many reasons. Integrating promotions capture and communication using wireless devices facilitates consumer interactions with goods and services providers and may enhance shopping experience for consumers. Using a wireless device to capture and communicate promotions may solve the problems presented above in lessening the burden on consumers to take separate actions for individual promotions. At the same time, capturing and communicating promotions using a wireless device increase communication efficiencies and allows consolidation of information about consumers so goods and services providers can generate specific promotions to target individual consumers more effectively.

### SUMMARY OF THE DESCRIPTION

The present invention relates to electronic capture and interactive communication of promotions using wireless devices. In one embodiment of the invention, a wireless device receives and stores targeted promotions specific to a user of the wireless device, sent from a promotion processing unit, upon receiving a store identification from an activated application on a wireless device. The promotion processing unit also sends the targeted promotions directly to the store point-of-sale. The wireless device receives and stores on-demand promotions of in-store merchandises, the on-demand promotions being different from the targeted promotions. The on-demand promotions are transmitted from the wireless device to the promotion processing unit which in turn applies the on-demand promotions either to a point of sale within the store or to be fulfilled after checkout.

In another embodiment of the invention, on-demand and targeted promotions redeemed at a plurality of different stores by a user are stored on a promotion processing unit. The on-demand promotions and the targeted promotions redeemed by the user are analyzed to determine the purchasing patterns of the user. In conjunction with at least one associated database servers, groups of new targeted promotions unique to the user and unique to each of the plurality of different stores are generated. When a store identification corresponding to any of the plurality of different stores is received by the promotion processing unit, the promotion processing unit will transmit one of the groups of new targeted promotions unique to the user and to the store identification to the user's wireless device and the checkout at the store so that the new targeted promotions can be redeemed by the user at checkout.

The present invention is described in conjunction with systems, clients, servers, methods, and machine-readable media of varying scope. In addition to the aspects of the present invention described in this summary, further aspects of the invention will become apparent by reference to the drawings and by reading the detailed description that follows.

### BRIEF DESCRIPTION OF THE DRAWINGS

Non-limiting and non-exhaustive embodiments of the present invention are described with reference to the following figures, wherein like reference numerals refer to like parts throughout the various views unless otherwise specified.

FIG. 1 illustrates an overview of a system to electronic capture and communicate promotion using a wireless device, in accordance to an embodiment of the invention.

FIGS. 2A to 2D illustrate store identification, on-demand promotions and product identification presented in various forms, in accordance with an embodiment of the invention.

FIG. 3 illustrates the capture and communication of promotions with a wireless device in a store, in accordance with an embodiment of the invention.

FIG. 4 illustrates an embodiment of communication interaction among promotion processing unit, different stores in different geographies, wireless devices and databases/vendors.

FIG. 5 is a block illustration of the flow of information in a system to capture and communicate promotions using a wireless device, in accordance with an embodiment of the invention.

FIG. 6 illustrates an embodiment of the promotion processing unit.

FIG. 7 illustrates a flow chart of the capture and communication of promotions using a wireless device, in accordance to an embodiment of the invention.

FIG. 8 illustrates a flow of information for on-demand promotions in accordance to an embodiment of the invention.

FIG. 9 illustrates a flow of information for targeted promotions in accordance to an embodiment of the invention.

FIG. 10 illustrates initial set up of a custom mobile application on the wireless device to communicate with a promotion processing unit in accordance to an embodiment of the invention.

FIG. 11 illustrates operation of a custom mobile application on the wireless device to communicate with a promotion processing unit in accordance to an embodiment of the invention.

### DETAILED DESCRIPTION

In the following detailed description of embodiments of the invention, reference is made to the accompanying drawings in which like references indicate similar elements, and in which is shown by way of illustration specific embodiments in which the invention may be practiced. These embodiments are described in sufficient detail to enable those skilled in the art to practice the invention, and it is to be understood that other embodiments may be utilized and that logical, mechanical, electrical, functional, and other changes may be made without departing from the scope of the present invention. The following detailed description is, therefore, not to be taken in a limiting sense, and the scope of the present invention is defined by the appended claims.

Reference throughout this specification to “one embodiment” or “an embodiment” means that a particular feature, structure, or characteristic described in connection with the embodiment is included in at least one embodiment of the present invention. Thus the appearances of the phrases “in one embodiment” or “in an embodiment” in various places throughout this specification are not necessarily all referring to the same embodiment. Furthermore, the particular features, structures or characteristics may be combined in any suitable manner in one or more embodiments.

Throughout this specification, several terms of art are used. These terms are to take on their ordinary meaning in the art from which they come, unless specifically defined herein or the context of their use would clearly suggest otherwise. The term “wireless device” includes, but is not limited to any mobile wireless devices such as, cellular telephones, personal digital assistants, or mobile handheld data processing devices that communicates and exchanges information using a cellular network or a wireless protocol. Wireless protocols include, but are not limited to, IEEE 802.11 series of protocols, and Bluetooth technology etc.

The term “promotion” generally refers to an offer made by a goods manufacturer/provider or service provider and may include, but is not limited to, offers for rebates, discounts, obtaining samples, entering a contest, testing new products and completing customer surveys, etc.

The term “targeted promotions” may be construed as a type of promotion that is targeted towards a user or customer based on a user's past purchasing behavior or pattern. “Targeted promotions” are not promotions selected or chosen by a user or customer, but instead are promotions that are pre-selected and sent to a user or customer to initiate interest from a store or store affiliate. Targeted promotions are generally store specific and user specific but may further be time specific, region specific or the like.

The term “on-demand promotions” may be referred to as a type of promotion that is personally selected by the user or customer. On-demand promotions may or may not be available for goods or services provided or found in a store. On-demand promotions may or may not be affiliated with a loyalty program associated with the store in which the on-demand promotion is found. On-demand promotions may be store specific, time period specific, geographically specific or the like but it is different from the targeted promotions because it is chosen by the user.

Furthermore, the terms “identification” and “code” may be interpreted as a means for a processor within a device such as a wireless device, a processing unit, or an electronic device of the like to identify a user, a product, a service, a promotion, or another device etc. The terms should not be construed narrowly in reference to numbers, but should instead be construed broadly to include symbols, letters, or all other possibilities that can be used as a form of “identification” or “code”.

The term “customer mobile application” refers to any application for a mobile wireless device that can run on multiple platforms. Examples of “customer mobile application” may include, but are not limited to, applications that are programmed in J2ME (Java 2 Micro Environment), BREW (Binary Runtime Environment for Wireless) and any object oriented cross-platform programming language.

A software module, or computer program product, may include a machine-readable medium having stored thereon instructions, which may be used to program a computer system (or other electronic devices) to perform a process. A machine-readable medium includes any mechanism for storing or transmitting information in a form (e.g., software, processing application) readable by a machine (e.g., a computer). The machine-readable medium may include, but is not limited to, magnetic storage medium (e.g., floppy diskette); optical storage medium (e.g., CD-ROM); magneto-optical storage medium; read-only memory (ROM); random-access memory (RAM); erasable programmable memory (e.g., EPROM and EEPROM); flash memory; electrical, optical, acoustical, or other form of propagated signal (e.g., carrier waves, infrared signals, digital signals, etc.); or other type of medium suitable for storing electronic instructions.

Unless stated otherwise as apparent from the following discussion, it will be appreciated that terms such as “identifying,” “selecting,” “determining,” “generating,” or the like may refer to the actions and processes of a computer system, or similar electronic computing device, that manipulates and transforms data represented as physical (e.g., electronic) quantities within the computer system's registers and memories into other data similarly represented as physical within the computer system memories or registers or other such information storage, transmission or display devices. Embodiments of the method described herein may be implemented using computer software. If written in a programming language conforming to a recognized standard, sequences of instructions designed to implement the methods can be compiled for execution on a variety of hardware platforms and for interface to a variety of operating systems. In addition, embodiments of the present invention are not described with reference to any particular programming language. It will be appreciated that a variety of programming languages may be used to implement embodiments of the present invention.

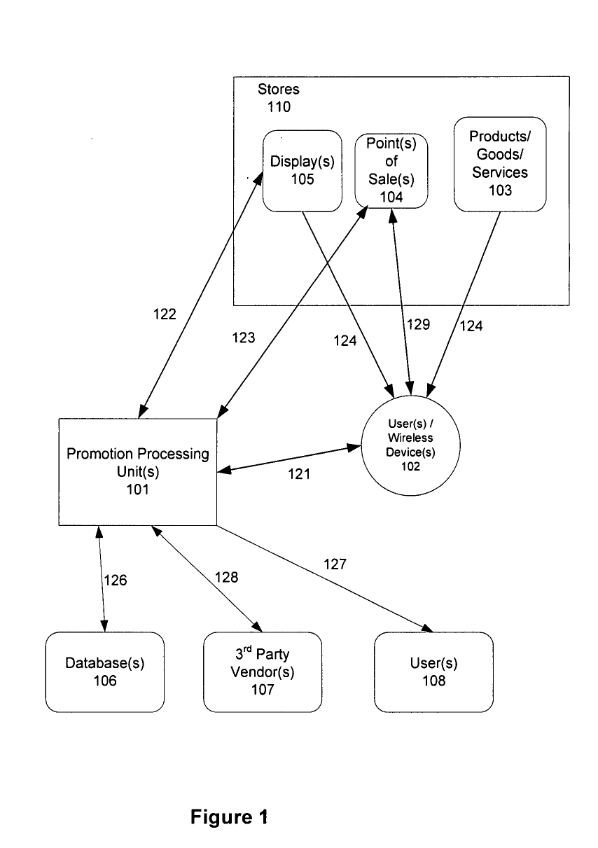

FIG. 1 illustrates an overview of a system to electronic capture and communicate promotion using a wireless device in accordance to an embodiment of the invention. According to an embodiment of the invention, products and services 103, display 105, and points of sales (POS) 104 are found inside a store 110. Note that displays 105 are not an essential component of the invention, but is commonly found in a store. A promotion processing unit (PPU) 101 is generally located outside of the store 110. The PPU 101 communicates electronically with the display 105 and POS 104 within the store. The PPU 101 electronically communicates and downloads information (e.g., targeted promotions) onto the wireless device 102. The PPU 101 also electronically interacts with database 106, third party vendor 107 and the wireless device user's home 108 or via a means of contact besides the wireless device.

In one embodiment, the wireless device 102 can receive targeted promotions directly downloaded from the PPU 101. This can be accomplished by direct text messaging, email or an alert. Alternatively, this can be accomplished through a specific application. In one embodiment, there is a two way communication 121 between the wireless device 102 and the PPU 101. A unique custom mobile application is uploaded by a user onto the wireless device 102 to allow it to communicate with the PPU 101. This custom mobile application also allows the user to receive and store targeted promotions, on-demand promotions, create a separate shopping list of items, and to create a list of favorite stores by storing store codes in which to easily transmit to the PPU 101. The list of favorite stores contains a list of store identifications or store codes so the user does not have to input that information repeatedly. The targeted promotions are automatically downloaded from the PPU 101 onto the wireless device once the custom mobile application is activated and a store code is sent from the wireless device to the PPU 101 and received by the PPU 101. The PPU 101 further transmits the targeted promotions to the POS 104 corresponding to the store identification or store code received so the targeted promotions can be redeemed by the user at checkout. For example, appropriate actions in redeeming the targeted promotions may include, but are not limited to, applying a discount when the user check-out, enrolling a user into a sweepstake, requesting a sample from a vendor to the user etc.

In one embodiment, stores 110 that is set up to provide such promotion interaction services may alert a user using at least one of Bluetooth technology or any location based services to alert a user that the service is available in the store. Such alerts may be in the form sending a user a text message or turning on an application on the wireless device as a user with a wireless device enters the store. For example, a user may click on a link in the text message to connect to the service.

In one embodiment, the custom mobile application on the wireless device 102 may be able to communicate via different wireless protocols, including, but not limited to WAP. Generally, a custom mobile application programmed on J2ME or BREW is the preferred or default platform of communication with a PPU 101. However, WAP may be used if the wireless device is not yet supported by J2ME or BREW, or if a user chooses not to download the application for any reason or simply only wants to try out the service available through the application for a limited duration.

The wireless device 102 may receive direct user inputs that include, but are not limited to, user identification (ID), user contact information, store codes or identifications (ID) and on-demand promotions. Some user inputs may be entered onto the wireless device 102 during the initial activation of the custom mobile application, while other user inputs may be after the custom mobile application has been activated. For example, the store ID and the User ID may be entered repeatedly and sent 121 to the PPU 101 each time the custom mobile application is entered. In another embodiment, the user ID and the store ID are stored and memorized in the custom mobile application of the wireless device and thus does not have to be entered each time the custom mobile application is activated. Still in another embodiment, if a user knows the store ID, the user may at any given time and at any given location download the on-demand promotions. The on-demand promotions are generally specific to merchandise available in particular stores and therefore most commonly entered during a visit in those stores. Input or transmission of the on-demand promotions or store ID or store Code is not location specific and a user can enter that information at any time or place where the wireless device has a connection to a cellular or wireless network. In one embodiment, these on-demand promotions may be transmitted to the PPU 101 individually after each on-demand promotion has been entered onto the wireless device 102. In another embodiment, the on-demand promotions are collectively sent as a list after a user completed shopping in a store.

In one embodiment, the store 110 is a partner of a customer loyalty program in which the PPU 101 administers. Under an arrangement, the PPU 101 downloads information including, but not limited to, on-demand promotional content and instructions to display the promotional content, on the in-store display 105. The on-demand promotional content may include, but not limited to, promotional content that are regionally specific, specific to the store, or specific to the merchandise or services that are available inside the store 110, or a combination thereof. The on-demand promotional content is different from the targeted promotional content downloaded directly from the PPU 101 to the wireless device 102. On-demand promotions are generally chosen by the user and available within vicinity of where products or services are displayed or on a physical packaging of the product. On-demand promotions may be specific to a store location for a limited duration. Targeted promotions are pre-selected for the user and sent to the user directly without having the user to visit any store. Targeted promotions may be store specific, but is usually specific to a chain of stores or common to stores in a region. Although targeted promotions broadly include promotions in a wider region or to a chain of similar stores, the promotions are specific to a user based on a user's past purchases. On-demand offers though not specific to a user, are specific to a store or duration. In yet another embodiment, selection of an on-demand promotion may trigger a targeted promotion of a similar or related item as the on-demand promotion to the wireless device.

While the store is a partner of the program in which the PPU 101 administers, the PPU 101 is also connected to the POS 104 in the store to facilitate the processing of promotions selected by user during checkout to eliminate the burden for the user to take separate action to process the promotions. For example, the targeted promotions are automatically sent to the POS 104 corresponding to the store ID once the PPU 101 receives the store ID information and the on-demand promotions are sent to the POS 101 without having the user to redeem them at the POS 104. Generally, there is a two-way communication 122, 123 between the PPU 101 and the display 105 and the POS 104, respectively. The PPU 101 sends instructions and promotional content to the display 105, while the display 105 reports status and error to the PPU 101. Similarly, the PPU 101 sends promotions to the POS 104 to be applied before a user checks out, but receives status reports and errors from the POS 104. In one embodiment, there may be a promotion distribution unit (PDU) (not shown) that acts as an intermediary to regulate distribution of promotional information from the PPU 101 to the display 105 and POS 104, and vice versa.

In one embodiment, the store 110 may be a partner of the customer loyalty program in which the PPU 101 administers and thus the POS 104 within the store 110 will be connected to the PPU 101. The targeted promotions may be sent directly to the POS 104 as described above. However, there may not be any on-demand promotions in the store which are to be displayed to promote products. For instance, there are targeted promotions available to the users in those stores. In an alternative embodiment, the store 110 may carry products or services in the store 110 in which the provider of those products or services are associated with the customer loyalty program that PPU 101 administers, even though the store 110 is not a part of the program. In this case, the on-demand promotion code may be present on the physical packaging of the product or labeled at or near the services and the user can redeem these on-demand promotions not at the POS 104, but via the PPU 101 which fulfills and redeems the promotion on behalf of the user. It should be appreciated that there are other manners in which the product or service ID and the on-demand promotion can be displayed and is not limited to the exterior packaging of a product. For example, if the on-demand promotion involves a sample offer of a product, the PPU 101 can request that sample offer be sent to the user. In another example, the on-demand may be a rebate, the PPU 101 can either request and sent a rebate coupon to the user or stores the information until next time the user visits a store where such a rebate is recognized and automatically applies the rebate offer at the POS 104 in such a store.

In another embodiment where the store 110 is not a partner of the customer loyalty program in which the PPU 101 administers, the PPU 101 may not be tied to the display 105 and POS 104 in the store. Under this circumstance, a product manufacturer or a service provider may be a partner of the customer loyalty program. The products or services associated with such a manufacturer or provider may be found in the store and there may be on-demand offers present on the packaging of the products or near a display of such services, as described above. The user will directly enter on-demand promotion from the goods/services 103 as communicated 124 on the product or services 103 such that the on-demand promotions may be redeemed by the PPU 101 on behalf of the user as described above, either by directly requesting or fulfilling the promotion or save the promotion to be applied at partnering stores at a user's future visit to one of those stores.

The PPU 101 also functions to interact with various databases 106, 3^{rd} party vendors 107 and the users 108 such as by means including, but not limited to, email, fax, telephone, mail, and text message etc. The databases 106 may house information that include, but are not limited to, user contacts, loyalty data, user preferences, past user purchases, past targeted and on-demand promotions redeemed by users, promotional contents of different retail stores, promotional contents of stores in different geographical locations, and headquarters of retail stores for instructions to display various promotions. The PPU 101 generally maintains a two-way communication 126 with the databases 106 to deposit and retrieve information. The third party vendors 107 generally refer to vendors who participate in the loyalty program but the promotions may or may not be redeemable in the store. Thus, the PPU 101 may contact the vendors 107 directly to process, execute, and fulfill the certain promotions selected by users, if the promotions are not redeemable in-store. Thus, the communication between the PPU 101 and the vendors are generally bi-directional 128. Sometimes, the PPU 101 can directly fulfill promotions and may directly send or contact the users 108 through a direct line of communication 127. This is often a uni-directional form of communication 127 from the PPU 101 to the user 108. In another embodiment, the wireless device 102 may directly interact with the POS 104 via a two way communication 129, by sending promotion information and receiving confirmation, when in a store using a wireless protocol, including but not limited to Bluetooth.

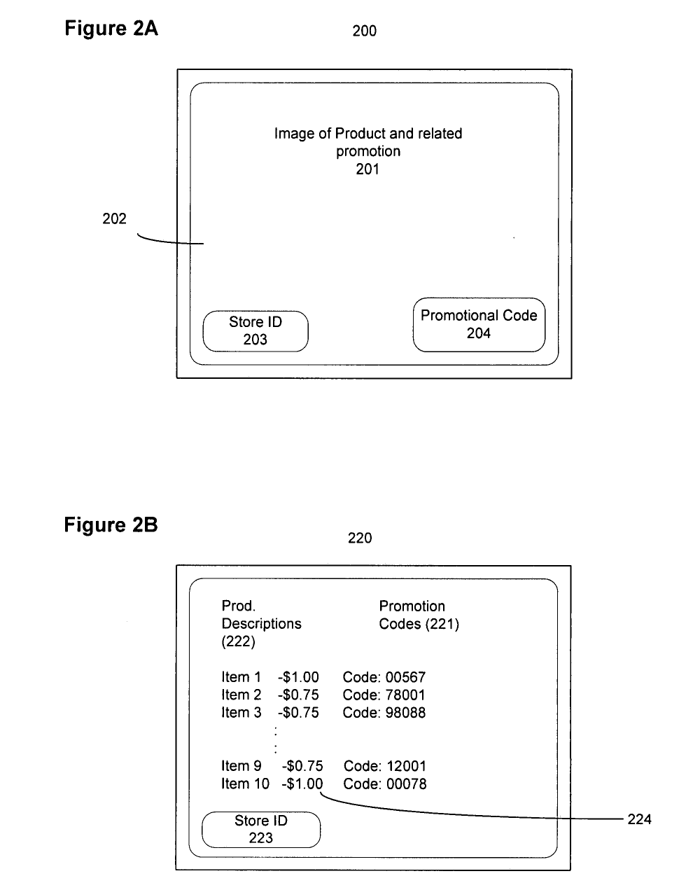

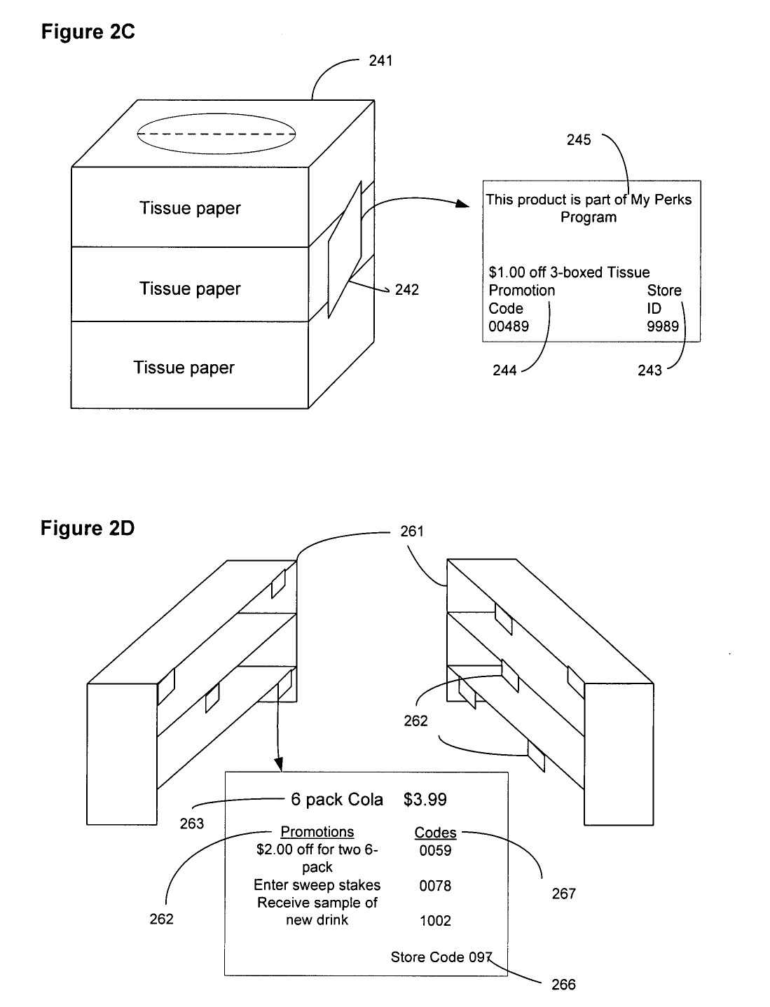

FIGS. 2A to 2D illustrate various different forms in which store ID and on-demand promotions can be presented in store, in accordance with an embodiment of the invention. FIGS. 2A and 2B are displays in the store. The displays can be static or dynamic. The displays can be located within close proximity of goods and services in which the promotional content is associated. As described in FIG. 1, the display may also be connected directly to a PPU (not illustrated here) or a PDU (not illustrated here). In another embodiment, the display can be independently operated by the local store or by a central server governing the promotional content under control of the headquarters of the store. In one embodiment, the content of the display is related to a promotion that is specific in the store. In another embodiment, promotion on display is related to a limited duration over a specified period of time. The promotions may or may not be common to other similar stores associated with a same chain of stores.

FIG. 2A shows a display 200 with an image of the product and the associated description of the promotion 201 in the center of the display. The store code 203 is displayed on the lower left hand corner, and the promotional code 204 is displayed on the lower right hand corner. FIG. 2A can be a static display or a dynamic display where the content on the screen 202 can be changed. For example, there can be a fixed number of products on promotion and those products and associated promotions will be alternately displayed, in a sequence. When the entire sequence has been completely displayed, the sequence will repeat from start to finish again. FIG. 2B illustrates a different embodiment of a display 220 where a list of different products and promotions are displayed. FIG. 2B shows a list of promotional codes 221, associated with the product descriptions 222 and the promotions 224. The store code 223 is presented on the lower left hand corner of the screen.

One can appreciate that the displays in FIGS. 2A and 2B can be in the form of an electronic display with video display or a static image display. The electronic display may be in the form including, but not limited to, a liquid crystal display (LCD), a plasma display, a high-definition television HDTV display, or a conventional cathode ray tube (CRT) display etc. The electronic display may be placed on the floor, hang from the ceiling, attached to an aisle, or placed any where the display can be prominently viewed by in-store customers. In one embodiment, the display displays on-demand promotions that are related to merchandise available in the store. In another embodiment, the display may include on-demand promotions available in the store where the display is located, but for a promotion that is redeemable outside of the store. This promotion may include, but is not limited to, an offer to complete a customer survey, an offer to try a new sample, an offer for rebates of an unavailable product, an offer to enter a contest, or an offer to try a service or product not available in the store, etc.

FIGS. 2C and 2D illustrate presentation of product ID, on-demand promotion and store ID in a form different than an electronic display. FIG. 2C shows the on-demand promotion ID 244 and an optional store ID 243 located on the exterior of the product packaging. The product 241 has an external sticker 242 on the package where the promotional and store information (244 and 243 respectively) are displayed. In one embodiment, the package may also indicate the product being a part of a loyalty program 245 in which the store is not a participant. This may be in a form of presentation including, but not limited to, description, color, trademark or logo etc. In this embodiment, it is possible that the store is not in partnership with the loyalty program associated with the PPU and thus there may be no need for a store ID. In a different embodiment, the store ID may also be included for data collection or another aspect of a promotion. However, the essence is that when a store is not a participant of the loyalty program, the promotion is likely to be associated with the product manufacturer or packager or provider. It should be appreciated that the promotion and product information can be located elsewhere besides the exterior of a product package even when the store is not a partner.

FIG. 2D illustrates an alternate method of presenting promotions, product ID and store ID in accordance to an embodiment of the invention. In this embodiment, products are displayed on the shelves 261 where there are small signs 262 associated with the products on display. There is more than one promotion 262 with associated promotion codes 267. The sign also contains product description 263 and the store ID 266. This embodiment may represent a store that opted to not use an electronic display or a store that has an agreement with the loyalty program to display the promotions but is not an actual participant on any of the promotional offers. It should be appreciated that a store may equally be possible to display promotional information on an electronic display or by another means if the store agrees to display the promotional information even though it does not actively participate in the offers.

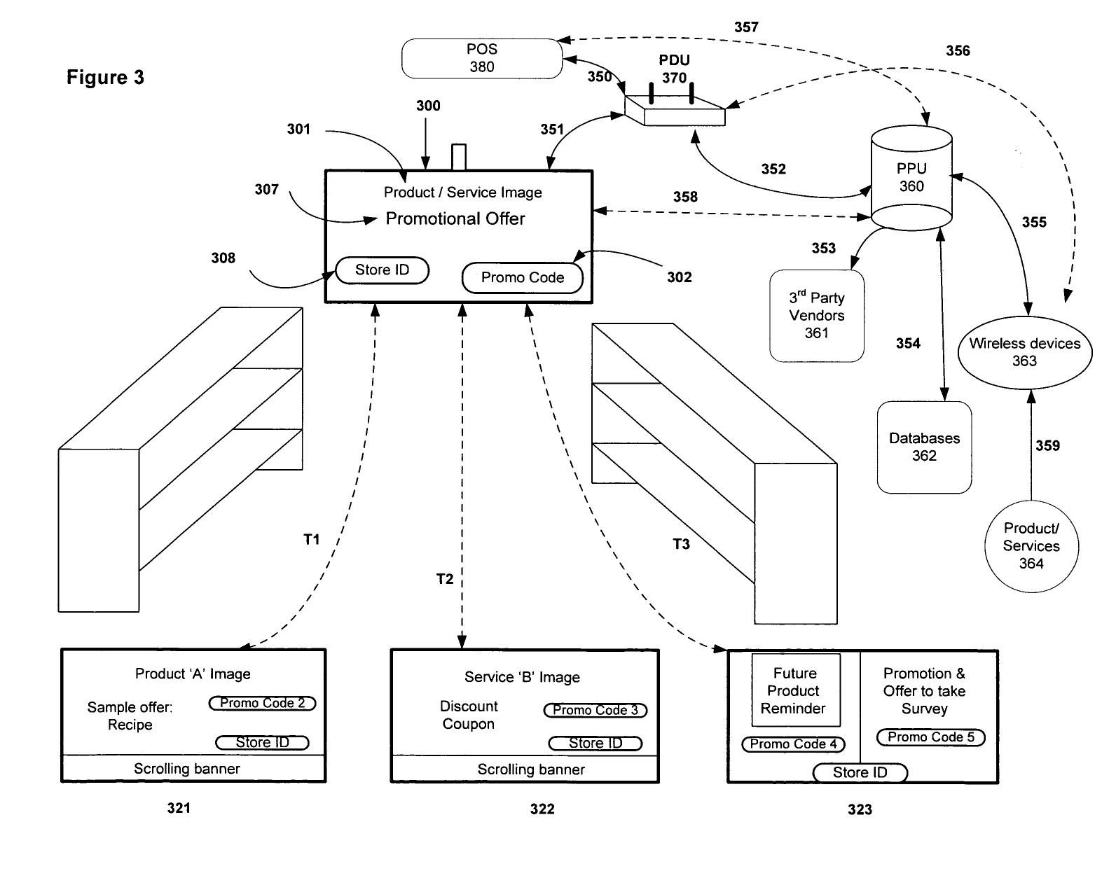

FIG. 3 illustrates the capture and communication of promotions with a wireless device in a store, in accordance to an embodiment of the invention. FIG. 3 shows one embodiment where an electronic display 300 is positioned near two product display shelves and hanging from the ceiling above the shelves. The electronic display is showing the description of the product or service 301, the on-demand promotional offer 307 for the product or service 301, the store ID 308 and the on-demand promotional code 302. In one embodiment, the electronic display may be a static display as shown in 300, but it may also display different promotions and images at different times, T1, T2 and T3 as shown by 321, 322 and 323. For example, display 321 shows a product image and a promotional offer to try a sample recipe. Associated with display 321 is a promotional code “2”, a store code and also a scrolling banner where news or other promotional information may be scrolling in real-time. In another example, display 322 shows an image of a service not available in the store, but associated is a promotion for a discount coupon with a promotional code “3” and a store code where the promotion is obtained. Similarly, this also has a scrolling banner to display other information. In yet a different example, display 323 shows a split screen of the display showing a promotion “4” for a reminder when a new product is released and a promotion code “5” to take a survey. While shopping, a user of the wireless device may respond to any of these promotional messages as seen on the display by selecting the promotion and sending it to the PPU 360. However, it should be noted that these promotions may be redeemed anywhere and need not be in the store. For example, one may be able to redeem such a promotion if one obtains the promotional code from a friend who purchased the item. For instance, if this promotion is for a discount, it may be redeemed at a store, but if it is for a sweepstake, one can redeem as long as one has access to a wireless network to communicate with the PPU.

In one embodiment, the store is a partner of the loyalty program and the promotional information and product information are shown on displays. It should be appreciated showing promotion information and product information on display is merely an exemplary embodiment, the same information may also be displayed in other form. The electronic displays 300 and POS 380 are connected to a promotion distribution unit (PDU) 370 which controls and regulate information to the display 300 and POS 380 from the PPU 360. There is a two-way communication 352 between the PPU 360 and the PDU 370. In this embodiment, the PDU 370, display 300 and POS 380 are all located in the store and may be communicatively coupled to at least one of a wired or wireless local area network (LAN), a wireless platform such as Bluetooth or IEEE 801 series protocol, or any other communication means well known in the art. The PPU 360 will send promotional information with instructions to the PDU 370 so the PDU 370 can carry out those instructions to display the promotional content. Similarly, the PPU 360 directly sends targeted promotions to a wireless device 363 and to the POS 380 so that the targeted promotions can be processed and applied to the user during check-out, or the PPU 360 can send on-demand offers received from the wireless devices 363 to the POS 380 to be processed at checkout. In turn, the PDU 370 will transfer status and error reports about the POS 380 and the display 300 to the PPU 360 for updates. Thus the communications 351, 350 between PDU 370 and the display 300 and the POS 380, respectively, travels bi-directionally. With a PDU 370, the wireless device 363 generally sends information through a cellular network to the PPU 360. The information travels bi-directionally 355 because the wireless device 363 sends the promotional info while the PPU 360 sends a confirmation of receipt.

In another embodiment, the wireless device 363 can by-pass the PPU 360 and communicate directly with the PDU 370 in the store with the use of a wireless protocol such as Bluetooth or IEEE 801 series protocol to avoid activating charges that may be involved in transferring data via a cellular network. In this embodiment, the PDU 370 may act as an intermediary to communicate the information to the PPU 360 so that other promotions that are not available in the store can be processed and fulfilled directly at the POS 380.

In a different embodiment, where there is no PDU 360 in the store, the PPU 360 can directly communicate with the display 300 and the POS 380 via links 357 and 358 respectively. The PPU 360 in this instance is likely to communicate with the display and the POS via the internet or world wide web (WWW) or another other means well known in the art. The PPU 360 will directly control the information exchange with the display 300 and POS 380.

In yet another embodiment as described earlier, if the store has no display 300 or is not a participant of the loyalty program administered by the PPU 360, promotional information may be directly entered 359 into the wireless device 363 by the user who is shopping or browsing the product or services 364.

The PPU 360 in any of the embodiments, will have a connection to a third party vendor 361, at least one other database 362 and to a user via his contact information (not illustrated). The communication to the database 362 and vendors 361 shown in links 354 and 353, respectively, performs specific tasks. Connection 353 to vendors 361 allows PPU 360 to fulfill promotions that are not available in the store. That also facilitates feedback to vendors 361 about the response to the promotions. Similarly, connection 354 to database 362 such as loyalty information, contact information allows PPU 360 or the database 362 to analyze user preferences and user purchasing pattern based on promotions selected and processed. This feature helps to generate targeted promotions specific to individual users to enhance shopping experience. Communication to users in addition to the wireless device enables the PPU 360 to directly fulfill certain on-demand promotion requests in a most efficient manner.

While the electronic capture and communication of promotions using a wireless device is illustrated in the setting of a store, it should be appreciated that this can equally be applied individually to different stores that are located in different geographies. Further it should be appreciated that one PPU 360 is possible to coordinate the capture and communication activities across different stores in different geographies.

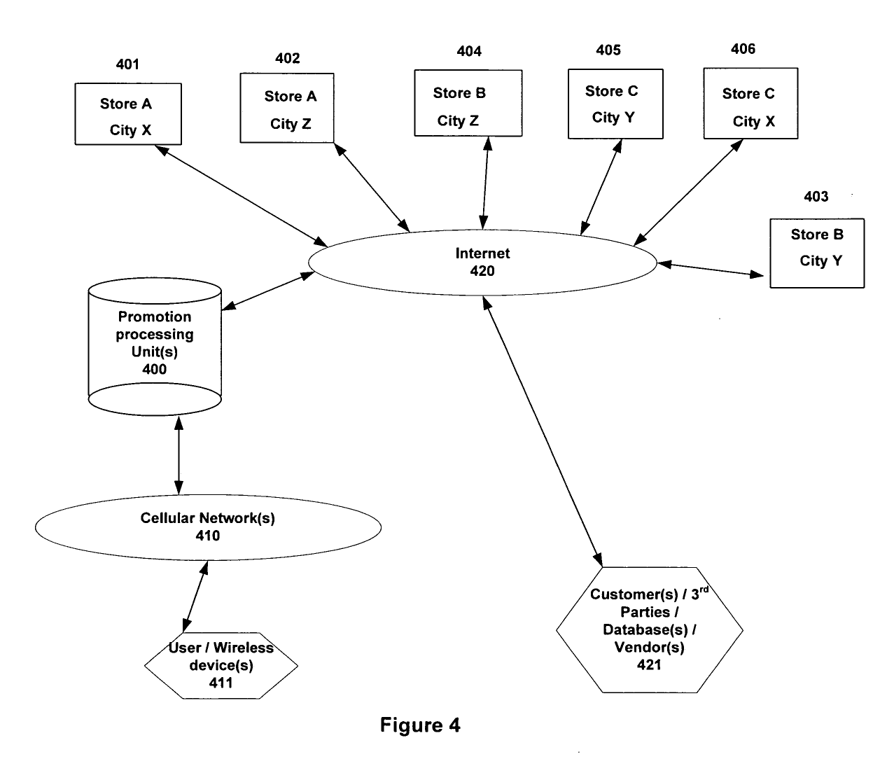

FIG. 4 illustrates an embodiment of communication interaction among a PPU, different stores situating in different geographies, wireless devices and databases/vendors 421 in different geographies. A PPU 400 is shown to be connected to the internet (or World Wide Web) 420 and a cellular network 410. The PPU 400 is communicatively coupled to the various stores 401-406 and other databases/vendors 421 via the internet 420 while at the same time communicatively coupled to wireless devices 411 via a cellular network 410. It should be appreciated that while one PPU 400 is preferred and sufficient to support such a configuration, more than one PPU 400 is also possible. The stores 401-406, include stores of the same chain located in different locations (e.g., stores A 401, 402) and stores of different chains located in a similar location (e.g., store B 403 and store C 405). In other words, the PPU 400 can connect similar or different stores at similar or different location or a combination thereof to manage flow of promotions. Thus, one PPU 400 is sufficient to control the multiple different promotions that are on-going for a range of different stores located in different locations.

Similarly, one PPU 400 is sufficient to interact with one or more databases/vendors 421 and one or more wireless devices 411. The PPU 400 has to communicate with different databases/vendors 421 to at least obtain promotional information, fulfill promotions selected by users, and to obtain contact information about users. In one embodiment, a PPU 400 has to retrieve promotional content from a database to download to one or a series of regional stores specifying the weekly promotions in the stores. In another embodiment, a PPU 400 has to retrieve customer information from a loyalty database to associate promotions and user ID sent to the PPU 400 for processing. In yet another embodiment, a PPU 400 has to send a user's contact information, retrieved from a loyalty database, to a vendor so the vendor can send the user a sample of a new product. In still another embodiment, a PPU 400 retrieves a rebate promotion for a service available outside of a store where the user visited and sends it to the user after retrieving a user's contact information from a loyalty database. It should be appreciated that the databases/customers/vendor/third parties 421 represents databases located in one or different locations. As an illustration and not by restriction, a PPU 400 communicates with databases/vendors to fulfill or execute selected promotions, retrieves information from databases, stores information into databases and communicates with users. In yet another embodiment, the PPU 400 by itself, or collaborate with another database server to identify user's purchasing pattern or behavior. User purchasing pattern are determined based on information collected about the targeted promotions and the on-demand promotions redeemed by a user at the POS and through the PPU. The purchasing pattern information is used to generate new targeted promotions specific to the users.

A PPU 400 is also responsible for an initial association of a user identification and store identification to transmit targeted promotions sent to wireless devices 411 via a cellular network 410. The user identification is generally stored and memorized by the custom mobile application after initial set up of the custom mobile application on the wireless device. The PPU 400 can generally identify the user through the wireless device from which the store ID or where on-demand promotion information is sent. While a cellular network 410 is used as an exemplary means of communicating information with the wireless devices, other alternatives are also possible. For example, other means such as WiMAX, WiFi, Bluetooth technology, IEEE 801 series wireless protocols are also possible.

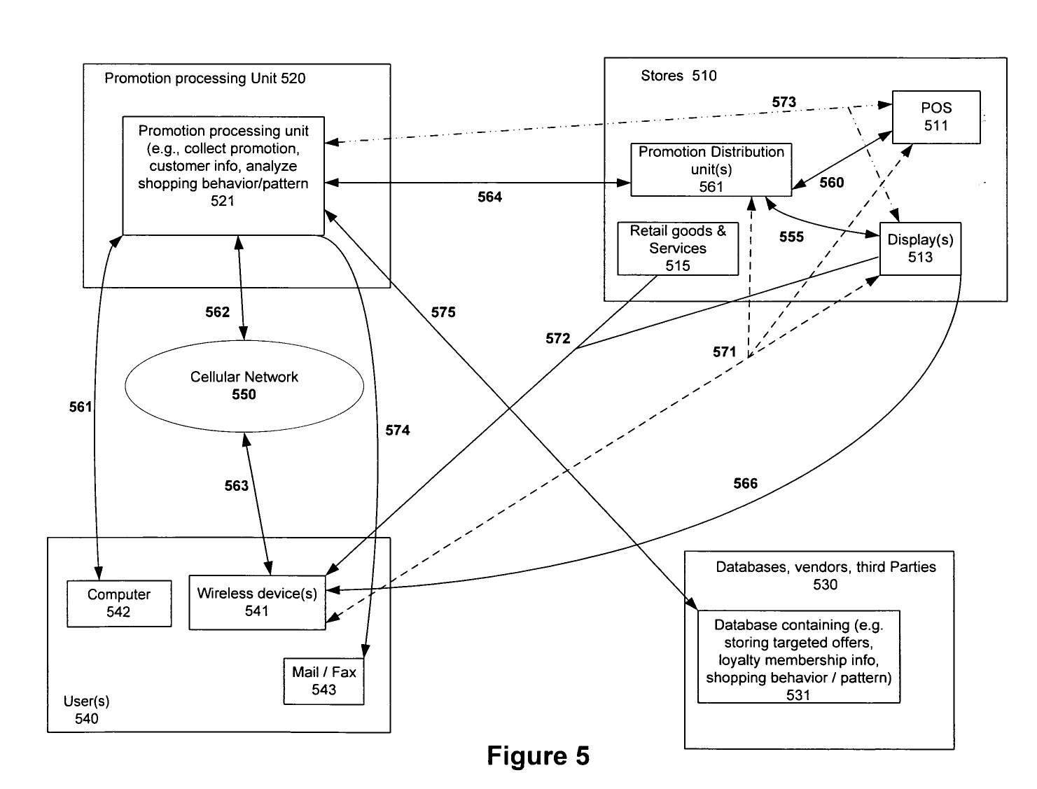

FIG. 5 illustrates a block illustration of the flow of information in a system to capture and communicate promotions using a wireless device, in accordance with an embodiment of the invention. FIG. 5 is similar to FIGS. 1 and 3 but illustrates all possible communication and information flowing among different components in a system. A preferred embodiment of information flow is illustrated by solid-lined arrows. Other alternative embodiments that can be incorporated are shown in the different dashed-lined arrows.

In a preferred embodiment, targeted promotions are sent via links 562, 563 from the PPU 521 to a user's wireless device 541 through a cellular network 550 after receiving a store code or store ID from the wireless device 541. Similarly if a store is a participant of a loyalty program and associated with the PPU 521, in one embodiment, the PPU 521 may download promotional content via link 564 into a PDU 561 located in the store. The local PDU 561 controls and manages the presentation of promotions via link 555 on in-store displays 513. The PPU 521 obtains promotional content from vendors/databases 530 via link 575 and may act as a regulator to transfer promotional information from, as an example, a store's head quarters to a retail store.

In one embodiment, before the user visits a store 510, the user activates an application on the wireless device 541, sends the store identification to the PPU 521 via links 563, 562 and the cellular network 550. Through the same path but in reverse, the PPU 521 transmits targeted promotions for merchandise or services specifically available in the store 510. In another embodiment, while shopping, the user sees an on-demand promotion of interest either directly from retail goods and services 515 or from an in-store display 513 and enters the on-demand promotion into the wireless device 541 which is in turn sent to the PPU 521. The store 510 may or may not be affiliated with the customer loyalty program in which the PPU 521 administers.

In one embodiment, where the store 510 is affiliated with the customer program that the PPU 521 administers, the on-demand offers may either be sent individually to the PPU 521 onto the POS 511 individually as the on-demand promotions are entered. In another embodiment, the on-demand offers are collectively sent as a list, which the user can edit before sending, to the PPU 521 and onto the POS 511 when shopping is completed. While the former is possible, sending on-demand promotions one at a time may not be as cost efficient as sending the selected promotions as a list because of charges incurred by the wireless device each time data is sent from a wireless device.

In another embodiment, where the store is not affiliated with the customer program that the PPU 521 administers, the on-demand offers may similarly be sent individually or collectively as described above to the PPU 521. However, the promotions will not be forwarded to the store POS 511 but instead be redeemed or fulfilled by the PPU 521.

In yet another embodiment, all the on-demand promotions sent to the PPU 521, whether they are sent to a store POS 511 or not, are stored and associated with the user. The PPU 521 may retrieve user's contact information and from a separate database such as 530 via link 575 to associate with the on-demand promotions. In another embodiment, the PPU 521 can send the on-demand promotions to another database 530 such that analysis on user preference and user's purchasing pattern may be performed based on past purchases and promotions redeemed. In a different embodiment, the analysis may be performed directly on the PPU 521. In another embodiment, records of targeted promotions redeemed by the users at checkout are stored and combined with information from the on-demand promotions redeemed by the user 540 to establish user preference and purchasing patterns. Since a list of targeted promotions are sent to the POS 511 upon receiving the store identification, the targeted promotions that are redeemed by the user at check out will be stored for analysis purposes.

In an alternative embodiment either when part or all of the on-demand promotions are not redeemable in the store POS 511, further action has to be taken to fulfill the selected promotions. As an example but not a restriction, when the on-demand promotion is to send the user 540 a customer survey or a reminder, the PPU 521 may contact the user directly via link 561 or 574 or even via 562, 563 and the cellular network, to email or mail/fax or call/text message, respectively, the survey or reminder. In other words, the PPU 521 is configured to directly interact with the user 540 provided the contact information of the user 540 is available either on the PPU 521 or via another database 530. As another example but not a restriction, when the selected promotion requires a vendor or third party 530 to take action, such as entering the user into a contest or obtaining a sample of a product from a manufacturer, the PPU 521 will contact the third party or vendor 530 with the user's contact information so the selected promotion can be redeemed or fulfilled without the user having to take additional action.

Other different embodiments of communication and capture of promotions that are in a store 510 using a wireless device 541 is also possible. In one embodiment when a user is in the store 510, it is possible that instead of using links 563, 562 and the cellular network 550 to capture and communicate promotions, the user can interact directly with the PDU 561 via dashed-line arrow 571. This is preferably performed over one of the familiar means of wireless communication well known in the art that may include, but is not limited to, Bluetooth, WiMAx, WiFi, and IEEE 801 protocols etc.

In one embodiment, the wireless device 541 transmits a store identification to the PDU 561 to receive targeted promotions from the PDU 561. Similarly, the wireless device 541 may also transmit on-demand promotions via the same manner to the PDU 561 which in turn communicates them to the POS 511. In another embodiment, the wireless device 541 transmits the on-demand promotions to the display 513 and/or the POS 511 directly and they in turn relay the information back through the PDU 561 to the PPU 521 for processing. In these two embodiments, there is a possibility of by-passing the PPU 521 and/or the PDU 561 entirely and interact directly with the POS 511 to redeem and fulfill on-demand promotions and/or to download targeted promotions locally in a store. However, if promotions have to be fulfilled by a third party or vendor 530 outside of the store, the promotions are transmitted to the PPU 521 either directly from the wireless device 541 as described earlier or via the PDU 561 through dashed line 571.

In another embodiment, if there is no PDU 561 in a store, a wireless device 541 can communicate either with the PPU 521 as described in a preferred communication means as described above, or redeem on-demand promotions directly at the POS 511 while downloading targeted promotions from in-store displays 513 directly. If communicating through PPU 521, on-demand promotions redeemable within the store are directly applied to the POS 511 and the ones fulfilled outside of the store will be fulfilled by the PPU 521. If communication is through POS 511 and/or in-store displays 513, on-demand promotions to be executed may or may not have to be transmitted from the POS 511 or the display 513 back to the PPU 521 for association with user identification. For promotions redeemable in the store, they are applied directly at the POS 511. For promotions that are not redeemable in the store, they are sent to the PPU 521 to be fulfilled.

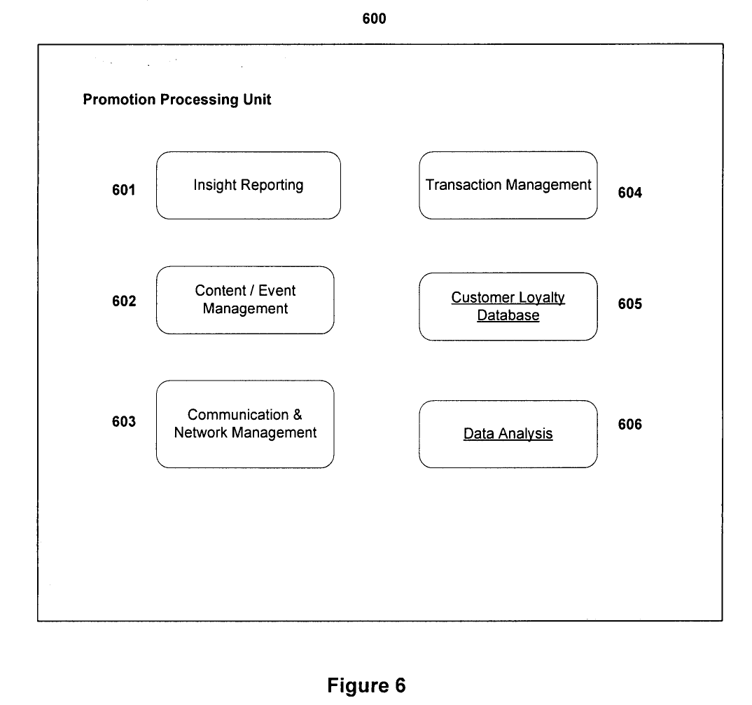

The PPU is an essential component of the system. FIG. 6 is a PPU in accordance with an embodiment of the invention. The PPU 600 can be configured to process a wide range of information and execute different actions. For example, PPU 600 may include one or any combination of the components 601-606 as illustrated. It should be appreciated that the PPU is illustrated for exemplary purpose and should not be construed in a restrictive sense. Other components known to an ordinary skilled person practicing the art of advertising and promotions may also be included. In one embodiment, the PPU 600 has a content/event management component 602 that organizes and instructs the display of unique on-demand promotions or presentations in a specific store, a chain of stores in a region, or an entire chain of stores. As an example and not a restriction, component 602 manages content, timing and other factors related to on-demand promotion displays and in-store events.

In another embodiment, the PPU contains a communication and network management component 603 to manage and control the information flow via the internet and the cellular network. This component is tasked with the management of information to at least one of the store (including PDU, displays and POS), the wireless devices, other databases, vendors and third parties, or a combination of the above. This component enables the PPU 600 to be communicative with other parts of the system via the internet, cellular network(s), other wireless protocols (e.g., Bluetooth, IEEE 801 series, WiMax, WiFi etc.), fax etc.

In one embodiment, the PPU 600 contains a transaction management component 604 that manages redemption and fulfillment of promotions. This includes applying targeted and on-demand promotions that are to be redeemed in a store in the form of rebates or discounts during check-out at the POS, fulfilling on-demand promotions that require third-party vendor involvement to redeem the promotions outside of the store, and fulfilling on-demand promotions through contacting the user by the PPU 600 itself. The transaction management component 604 ensures that each user's targeted and on-demand promotions are processed and thus giving the advantage of removing such burden from users.

In another embodiment, the PPU 600 may contain a customer loyalty database 605. Though it is common to store customer loyalty and contact information in a database separate from the PPU, storing the information as part of the PPU 600 facilitates retrieval and access of customer information. A database component associated within the PPU 600 reduces the need of a PPU 600 to reach outside via an external network to obtain the same information and result in an improved response to retrieving and storing information.

In one embodiment the PPU 600 may contain a data analysis component 606. The data analysis component 606 is responsible for sorting and analyzing targeted and on-demand promotions redeemed by the users. It may also compile statistics based on analysis of information. Data analysis may include but is not limited to determining the popularity of certain merchandise available in store, the promotion(s) which are most popular to users, the most effective promotions, the least effective promotions etc. The data and/or statistics generated are used to assist the goods and services provider to modify their marketing strategy and to provide feedback on their products and services. This component may also perform analysis on redeemed promotions to provide information used by the insight reporting component to generate improved targeted promotions directed to specific users based on the specific user's purchasing pattern and behavior. The data analysis component 606 is aimed to improve the effectiveness of the promotions to goods and services offered.

In still another embodiment, the PPU 600 may contain an insight reporting component 601 that determines user preferences and user purchasing behavior. The insight reporting component 601 is focused on identifying individual users' preferences based on the promotions redeemed. The results are used to further individualize promotions targeted to an individual. For example, by analyzing the frequency in which a user selects a promotion related to a particular product and the different classes or categories of promotions in which a user typically selects, the insight reporting component can recommend to a vendor/manufacturer the products and services that most interest the user so the vendor or manufacturer can target in the future products and/or promotions related to or within the areas of interest to the user.

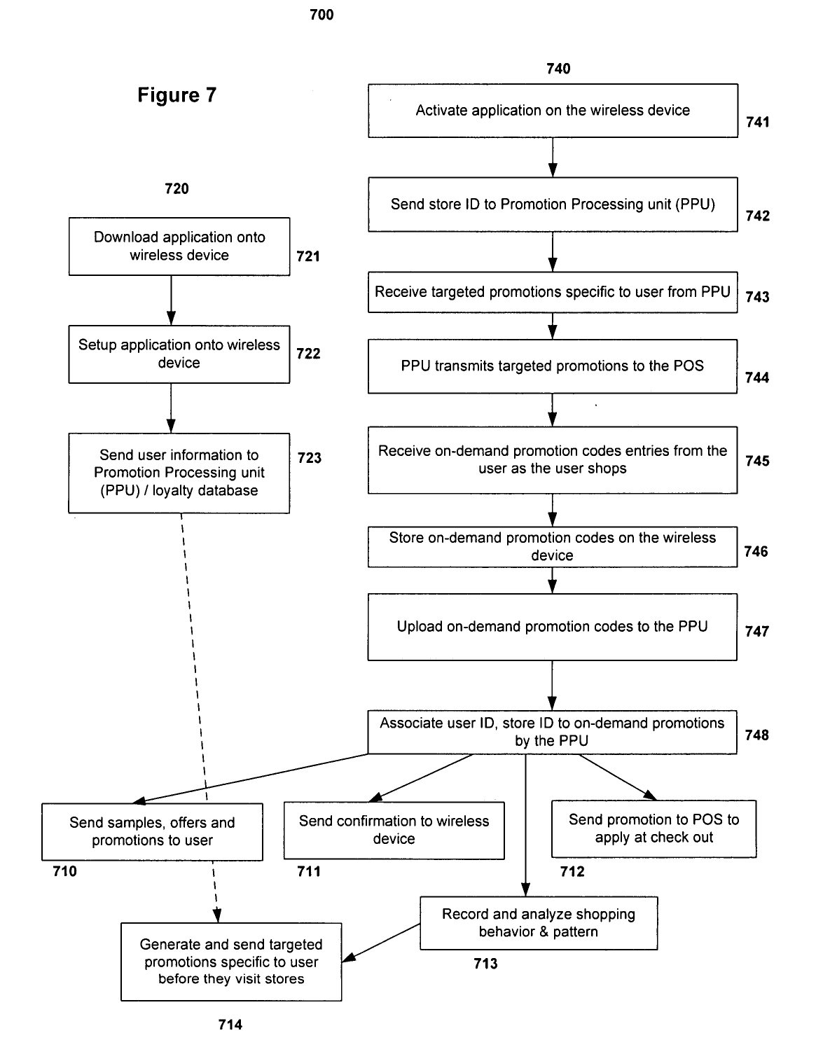

FIG. 7 illustrates a flow chart of the capture and communication of promotions using a wireless device, in accordance to an embodiment of the invention. The flow chart 700 has two parts, the first, 720, relates to initiating the application and the second, 740, relates to actual capture and communication of promotions using the wireless device. 720 illustrate a series of events for activation of a wireless device to enable capture and communication of promotions. Event 721 involves the download of an application onto a wireless device. In one embodiment, the application may be J2ME, BREW, and WAP compatible. However, it should be appreciated that the application may be programmed to any wireless protocol for communication with a PPU and/or other components that may be located in the store such as a PDU or POS or in-store display. Event 722 is to setup the application onto the wireless device. The setup may include but not limited to setting up user identification or defining fields that are personal to the user. The application will be described in further details below. Event 723 is to send user information to the PPU so that the user's information can be stored and in the future be associated with the user's ID which may include but is not limited to a phone number, an email address, a home address, or a loyalty program membership number etc. According to event 714 after the user information is sent to the PPU, the PPU can generate and send targeted promotions to the user. Most commonly, the PPU will send targeted promotions to the wireless device, similar to a user's request, after a user activates the application and sends in a store ID. In another embodiment, the PPU may send targeted promotions to the wireless device via text messaging or email at a periodic interval. The interval at which the targeted promotions are sent to a user can vary. This may be pre-determined by the PPU or it may be pre-set as part of the initial setup as specified in event 722.

The second part, 740, describes the electronic capture and promotion of promotions using a wireless device. Event 741 describes a user activating the application on a wireless device. Event 742 describes a user entering a store ID onto the wireless device and transmitting that to the PPU. This typically can occur any where, at home before the visit to a store, in the store, or any where else. Event 743 describes a wireless device receiving targeted promotions from the PPU after the store ID is sent from the wireless device to the PPU. Although it is possible the targeted promotions are received on the wireless device while a user is shopping in the store, an object of the targeted promotions is to provide advanced notice of promotions to attract a user to visit the store. Event 744 describes a PPU sending targeted promotions to the store POS upon receiving the store ID. This occurs if the store is affiliated with an entity managing a customer loyalty program which is administered by the PPU or if the store administers the customer loyalty program itself and controls the PPU. The targeted promotions can be readily redeemed by the user when the user checks out. Typically the targeted promotions will remain available for redeeming at the POS for a pre-determined period not longer than one day and may be limited in quantity where a user cannot redeem more than a specified limit. Event 745 describes a user entering on-demand promotions into the wireless device as the user shops in the store. Event 746 describes the wireless device storing the list of on-demand offers entered onto the wireless device as a record history for the user to review in future. Event 747 describes transmitting the on-demand promotions from the wireless device to the PPU so the PPU can fulfill the promotions for the user or to send the promotions to the store POS for the user to redeem at checkout. In one embodiment where the store is an affiliate to the customer loyalty program, at least a portion of the on-demand offers will be sent to the POS for redemption. In an alternate embodiment of this event, the on-demand promotions are associated with the products and/or services in a store that is not a partner to a loyalty program. In this case, the on-demand offers will not be sent to the store POS and all of the on-demand offers may be fulfilled by the PPU as later described in events 710, 711 and 712. Event 748 describes the PPU associating and storing the on-demand promotions with the user information.

Events 710, 711 and 712 represent the actions taken by the PPU after the on-demand promotions are associated on the PPU. Event 711 shows the PPU sending a confirmation to the wireless device to notify the user that the selected promotions are received. A confirmation may be sent once if a collective list of on-demand promotions is sent from the wireless device to the PPU. Alternatively, if the on-demand promotions are sent one at a time, a confirmation may be sent from the PPU after each on-demand promotion is received by the PPU, or a confirmation may be sent once the user indicates that no more on-demand offers are to be sent or terminates the application. Event 712 shows the PPU sending on-demand promotions to be redeemed at the store POS application during check-out. On-demand promotions redeemable at the store POS often include, but are not limited to, discounts and rebates. Event 710 shows the PPU sending the on-demand promotions to be fulfilled by a third party or vendor. These promotions generally include, but are not limited to, obtain sample products, entry to contests, offers redeemable outside of the store.

Events 713 and 714 show the actions taken by the PPU using the on-demand promotions received from the wireless device and redeemed targeted promotions stored for reference. Event 713 shows the analysis of on-demand promotions for user preference and shopping behavior and pattern of the user. Event 713 corresponds to the actions taken by components 601 and 606 as described in FIG. 6. One result of the actions of Event 713 is to generate and send targeted promotions specific to users, indicated by event 714. The use of the information derived from the redeemed promotions to improve promotions to products and services offered as related to 606 is not illustrated.

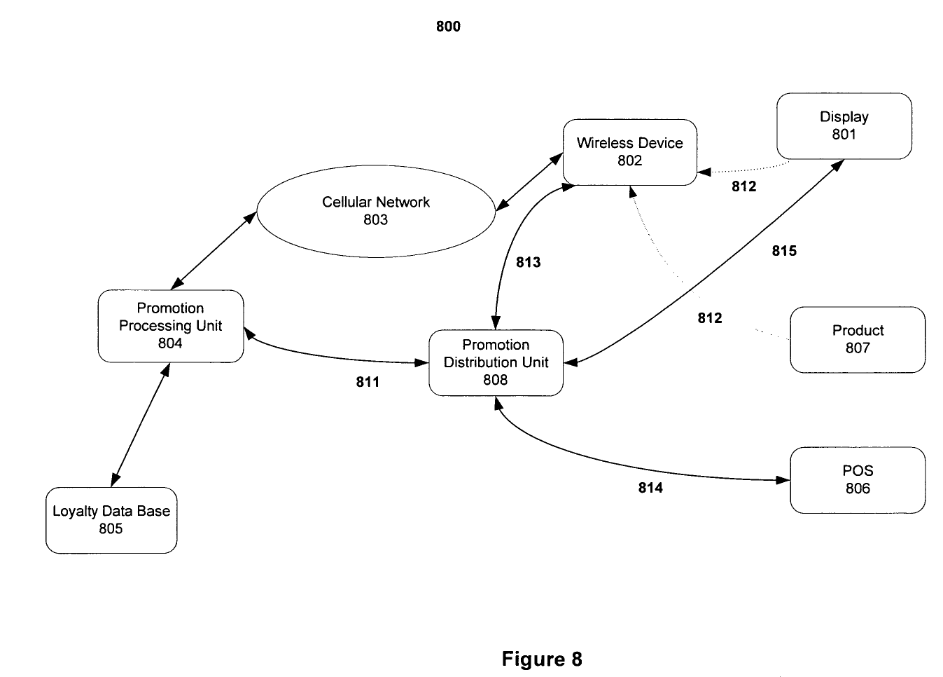

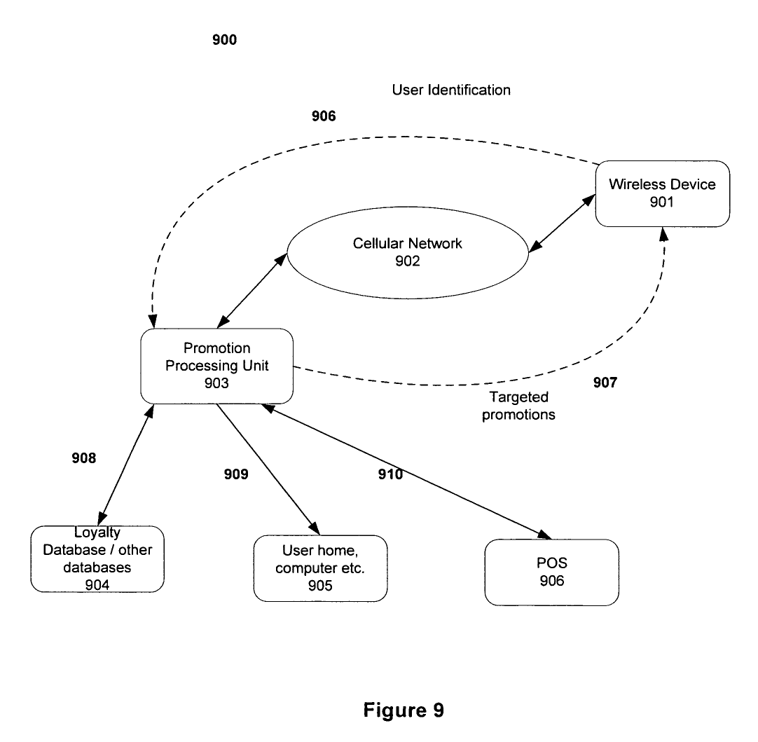

Improving shopping experience and customizing shopping experience to an individual user is an object of this disclosure. Targeted promotions and on-demand promotions are essential parts of the system to achieve those objects. FIGS. 8 and 9 illustrate the flow of information to generate targeted promotions and on-demand promotions, in accordance to an embodiment of the invention.

FIG. 8 illustrates the flow of information in redeeming and generating on-demand promotions using the wireless device. FIG. 8 shows the various components in the system involved in handling of on-demand promotions. As described earlier, on-demand promotions are selectively entered onto the wireless device 802 by the user. The user may obtain the on-demand promotions directly from the product 807 or from the display 801 through visual contact 812. A user generally first activates the application on the wireless device to communicate with the PPU 804. In the case where the store is an affiliate of the customer loyalty program administered by the PPU 804, entry of the store ID will be sufficient to cause the PPU 804 to receive the on-demand promotions to be applied to the store POS 806. If a store is not a participant of the customer loyalty program, a user may enter in a different code in place of a store ID so the PPU 804 is aware that the PPU 804 is to fulfill the on-demand promotion or to be saved to be sent to a different POS in a different store.

In an alternative embodiment, instead of interacting w/ the PPU 804, the wireless device 802 interacts with the PDU 808 to communicate the on-demand offers from products or display to the POS 806 and the PPU 804. A two way communication 813 allows the wireless device to select and send on-demand offers and to receive confirmation that the on-demand offers are received. The PDU 808 in turn sends on-demand offers to the PPU via a two way communication link 811 to associate on-demand offers to the users' identifications and relays the promotions to be redeemed in the store to the POS 806 via communication link 814. Furthermore, the PDU 808 also acts to regulate the display of promotional content onto the in-store displays 801 using instructions from the PPU 804 via communication link 815. Communication between the wireless device and the PDU 808 is typically local and limited to within the store. Bluetooth, IEEE 801 based wireless protocol etc. are typically employed instead of a cellular network. A limited range of data transmission may be a means for a store or a chain of stores to ensure that certain promotions can be redeemed by store visitors and not if users of the wireless devices are not present in the store. Alternatively, the set up may allow a wireless device 802 to directly interact with the display 801 to download in-store on-demand offers, and to communicate selected promotions to the POS 806 directly without the use of a PDU 808 in the store. In this case, the PPU 804 may in some form be directly connected to the displays 801 and the POS 808.

On-demand promotions include, but are not limited to, promotions specific to the chain of stores, specific to the region where the store is located, specific to particular goods and services available in the store, specific to a time frame or a combination thereof. On-demand promotions are intended to appeal to impulse purchases, and are intended to attract shoppers who are visiting the store. On-demand offers, unlike targeted promotions, are targeted to a specific store location, with a specific objective that is not to lure a shopper or user to visit a store, but focused instead on getting rid of excess inventory, promoting a new product which is shoppers are unfamiliar, objectives to increase sales in a particular locale or to appeal to visitors in the store.

FIG. 9 illustrates the flow of information in placing targeted promotions in the wireless device. Placing targeted promotions onto wireless devices is different from redeeming on-demand promotions because targeted promotions are often sent by the PPU 903 and triggered by the user, for instance, when the user activates the application on the wireless device to create a shopping list or add items to a shopping list. In one embodiment where targeted promotions are pushed onto the wireless device without triggering by a user, the user may be able to determine the interval or regularity in which targeted promotions are automatically sent without the need for the user to activate the wireless application. More commonly, however, targeted promotions are triggered by the user's activation of a specific application on the wireless device and the transmission of a store ID to the PPU.

FIG. 9 shows a PPU 903 communicatively coupled to the wireless device 901 via cellular network 902. Targeted promotions are generated in the PPU 903 or in other databases such as the loyalty database 904 or by a combination of both PPU 903 and other databases after the user preferences and user purchase patterns are analyzed. In one embodiment, targeted promotions are different from on-demand promotions in that they are unique to a user and to the store ID in which the user transmits to the PPU 903. Targeted promotions are designed to appeal to the user to motivate the user to visit the store or to make additional purchases while visiting the store by introducing promotions that are thought to be interested to the user based on the user's past purchasing behavior.

PPU 903 generally uses past targeted promotions redeemed by a user to a chain of stores or specific store to establish a past purchasing pattern. In another embodiment, on-demand promotions redeemed by the user in the past are also used to establish such a pattern. User identification is communicated to the PPU 903 in the direction 906 from the wireless device 901 to the PPU 903 through the cellular network. User identification helps to establish a profile upon the initial set up of the user application by supplying information to the loyalty database 904. The loyalty database 904 also stores shopping history that may include, but is not limited to, targeted promotions redeemed, on-demand promotions redeemed, past purchases not related to promotions, and contact information etc. Targeted promotions are transmitted to the wireless device 901 in the direction 907 through the cellular network. PPU 903 communicates and exchanges information with the loyalty database or other databases 904 generally via the internet. The loyalty database or other databases 904 cooperates with the PPU 903 to generate targeted promotions for each user for each store ID. Generally, targeted promotions are sent automatically from the PPU 903 to the POS 906 when it receives a store ID entry from the user's wireless device 901 so that the targeted promotions can be applied at the user's checkout. These targeted promotions may be stored temporarily on the POS 906, for example, within a fixed duration such as the end of the same business day, for a user to redeem. In one embodiment, targeted promotions are generally specific to a unique store ID, meaning the targeted promotions are promotions specific for the users at a particular store, where the particular store is also a participant of a loyalty program administered by the PPU 903. In another embodiment where targeted promotions are not redeemable in the store, the PPU 903 may directly fulfill the targeted promotions and communicate the offers to the user at home, to the user's computer etc. via link 909.

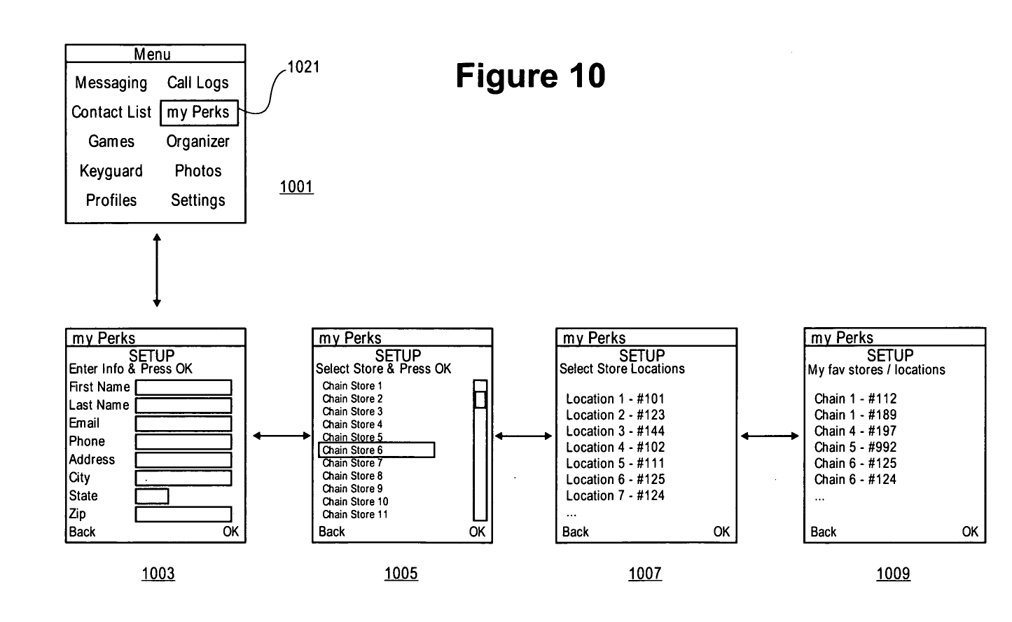

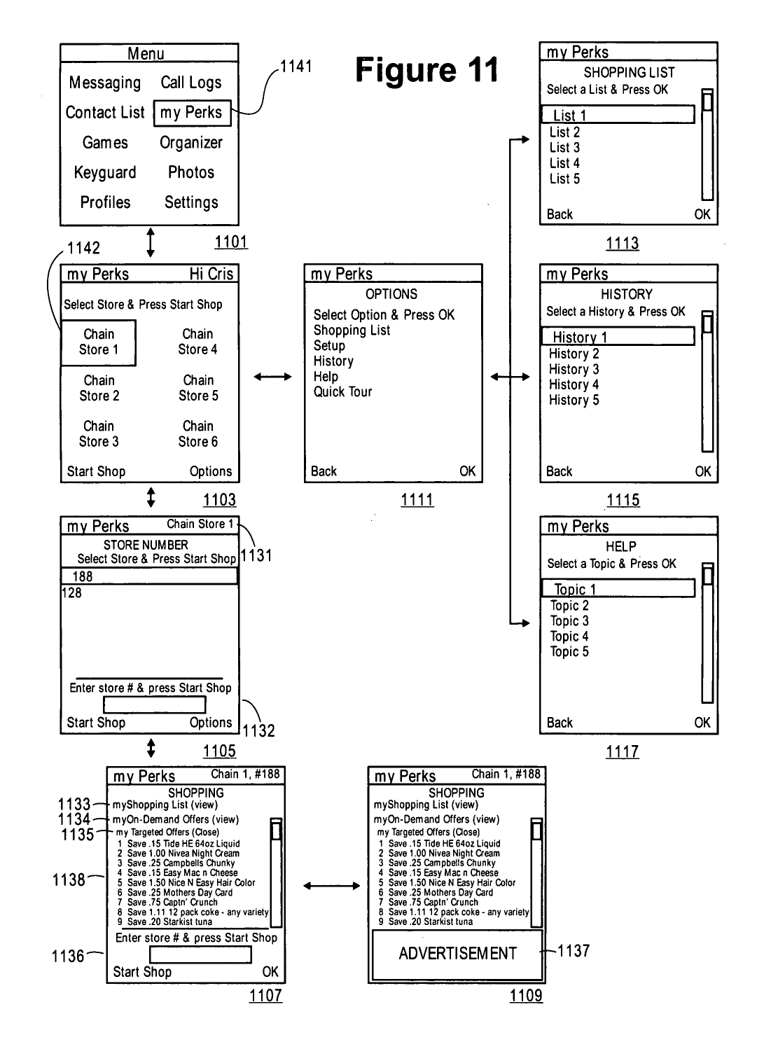

FIGS. 10 and 11 describe an embodiment of an application on the wireless device to communicate with a PPU in accordance to the invention. FIG. 10 illustrates an initial set up of the application on the wireless device and FIG. 11 illustrates the operation of the application by a user once it has been pre-set and programmed.

FIG. 10 illustrates a series of exemplary screen displays in an initial set up of an application on the wireless device. It should be appreciated that the display illustrations are exemplary and should not be construed narrowly in a restrictive sense. One ordinary skilled in the art may choose to display the initial set up in a different manner but still incorporate the essence of the application in interacting with the PPU. Before describing the application setup, it should be appreciated that the application may be loaded onto the wireless device in any of a number of ways. The application may be preloaded by the wireless device manufacturer, downloaded from the wireless carrier from a website or a remote server, texting a code to a phone number to get a text message back with the url (universal resource locator) to download the application, docking a USB device at a retailer's customer service desk to download the application, or to download via Bluetooth from within a store etc.

Display 1001 is a menu of the wireless device. This menu may be in text or in the form of icons or logos. The application, feature 1021, “my perks” is activated once it has been selected. After the application is activated, display 1003 requests for personal identification information including but not limited to address, phone number, customer loyalty number, email etc. from the user to prepare a profile. A user may enter the information directly on the wireless device, or alternatively, enter information via a website prior to downloading the application. Display 1005 displays the list of chain stores (e.g., chain stores 1-11) that are participants to the loyalty program which is administrated by the PPU. A user may scroll down the list and hit “OK” to select. A chain store typically means a store carrying similar merchandise and services but having multiple locations. For example, some examples of a chain store well known are Best Buy, Target, Macy's etc that carry similar items in each store of the chain but have multiple locations. A user can scroll and select the chain store of interest. Once a chain store is selected (e.g., Chain store 6 as illustrated), display 1007 prompts the user to select locations of the store which are frequently visited by the user. For example, assuming chain store 6 is selected in display 1005, display 1007 shows multiple locations (e.g., locations 1-7 of chain store 6) for a user to similarly scroll and select a location of interest. Once a store location has been selected, it is displayed along with other selected locations in a “my favorite stores and locations” as illustrated in display 1009. My favorite stores and locations is simply a list of stores and locations which are frequented by the user and thus allows the user quick access to those store IDs for retrieval after the application has been set up. This process may be repeated and multiple chain stores and multiple locations per chain stores may be selected and stored on the wireless device.

FIG. 11 illustrates a series of displays that are representative of the application after it has been set up to interact with the PPU. Similar to the displays shown in FIG. 10, these displays are merely an exemplary representation of the application and should not be construed in a restrictive sense. The same unique features and functions of the application are not limited to the displays as illustrated, other alternate forms of display may be employed to carry out the disclosed features and functions by one with ordinary skills in the art.

FIG. 11 illustrates the operation and functions of the application in accordance to one embodiment of the invention. Display 1101 is a menu of the wireless device. The menu may be displayed in a form of text, logos, or icons etc. Once the application, for example, “my perks” 1141 has been selected and activated, the application will take the user to two possible options. In one embodiment, displays 1103 and 1105 may appear to prompt the user to select a retail chain store and a particular location of the retail chain store as illustrated in the set up as shown in FIG. 10. For example, display 1103 asks a user to select among chain stores (e.g. chain stores 1-6) and once a chain store (e.g., chain store 1, 1142) is selected, the user is further asked to select a location of the store. The selected chain store (e.g., chain store 1, 1131) is also displayed on the screen to remind a user the store in which the promotions he/she is viewing are related. The store location may be selected by scrolling, or, by manual entry 1132 as shown. In another embodiment, once the set up has been completed, it may directly jump to a display (not shown) displaying my favorite stores and locations (similar to display 1009 illustrated in FIG. 10), so the user can conveniently select a store location previously stored. Once a store location has been selected, the PPU will receive the store ID and send a list of targeted promotions in accordance to an embodiment previously described.

Displays 1107 and 1109 illustrate the essence of the application. Display 1107 contains three lists, a shopping list 1133, an on-demand promotions list 1134, and a targeted promotions list 1135. The shopping list 1133 and the on-demand promotions list 1134 can be modified. However, the targeted promotions list 1135 may be viewed and not edited. The targeted promotions list 1135 is downloaded from the PPU after the store ID is received by the PPU. The content of the list may be viewed as a scrollable list 1138 or in other different views (not shown). The purpose of this list in the application is to allow the user to view the targeted promotions available to the user so the user may gather and collect the items of interest when the user is in the store to bring them to check out. Since the targeted promotions are automatically sent to the POS and associated to the user by the PPU, the user may bring the items to checkout to and does not have to take additional measures to redeem the promotions. The targeted promotions that are not redeemed because the user chooses not to buy those items will simply be ignored by the POS.

The shopping list 1133 and the on-demand promotions list 1134 are created by the user. In one embodiment, the shopping list 1133 may be specific to a series of stores in a chain or specific to a specific store location. Because each product may be uniquely identified by a store or chain of stores, the shopping list is generally created on the website of the chain store and downloaded onto the wireless device through the PPU. In an alternative embodiment, the shopping list may be created by the user on the wireless device using the application to browse the chain store's website.

The on-demand list is created by a user entering on-demand promotion codes associated with products or services. In one embodiment, there is one on-demand promotions list corresponding to each unique store ID. Reason for one on-demand promotions list corresponding to each unique store ID is so that the on-demand promotions on that list can be applied to the store's POS when the user checks out. In one embodiment, while there may be one on-demand promotion list corresponding to each unique store ID, the shopping list may be same for multiple stores, provided those stores are of the same chain, carrying similar products and services. In another embodiment, similar to the on-demand list, there may be one shopping list on display for every unique store ID and this shopping list may be specific to the specific store corresponding to the unique store ID or a list common to stores within a chain.

As illustrated in display 1107, the on-demand promotion codes are entered into the wireless device on the bottom of the screen one at a time, regardless of which list is being displayed. In one embodiment, after each on-demand promotion ID is entered it is sent to the PPU immediately. In another embodiment, on-demand promotion IDs can be entered and gathered together as a list, as displayed in the on-demand promotion list, before sending to the PPU.

Display 1107 illustrates while the application may display multiple different types of lists on the same display, items from one list are displayed at a time. In one embodiment, one list can be expanded at once. In a different embodiment, multiple lists of items can be expanded at once. For example, the collective items 1138 in the targeted promotions list are in view because the targeted promotions list is expanded. Items in other lists which are closed or unexpanded cannot be viewed. For instance, in display 1107, “my shopping list” and “my on-demand offers” are closed and therefore the items in those lists are not visible. More different types of lists may be present in display 1107 than illustrated. For example, the list of my favorite stores may also be included, but the actual stores in the list will not be visible unless the list is expanded.

Another feature is the interchangeable area in the display of the application. Displays 1107 and 1109 illustrate that the manual entry area 1136 for on-demand promotion codes may be interchangeable with the display of an advertisement 1137. The advertisement 1137 may replace the manual entry area 1136 if no user entry is received within a time duration. Numerous advertisements may be alternately displayed, similar to a changing billboard. However, once the application senses a user initiating an entry, the advertisement will be replaced by the manual entry area display again.

Display 1111 shows a list of options available to the user if the user selects “option” in display 1103. In one embodiment as shown, the list of options include the ability to view and edit shopping list, perform setup for the application, view history of past promotions redeemed, a help menu, and a guided tour. The shopping list may be presented in the form of display 1113 where different shopping lists corresponding to either a chain of stores or individual stores can be selected for viewing or editing. Similarly, the history list may be presented in the form of display 1115 where past shopping history, for example, illustrated by date of purchases, may be available for review. Multiple different ways of sorting and displaying the items in the shopping list, the targeted promotions list, the on-demand promotions list and other lists may be possible. The help menu may be presented as shown in display 1117 and structured based on topics. Set up and guided tours are not shown, but the object of those selections are to change user preferences and set up of the application or to take a virtual guided tour on how to use the application, respectively.

The above description of illustrated embodiments of the invention, including what is described in the Abstract, is not intended to be exhaustive or to limit the invention to the precise forms disclosed. While specific embodiments of, and examples for, the invention are described herein for illustrative purposes, various equivalent modifications are possible within the scope of the invention, as those skilled in the relevant art will recognize. These modifications can be made to the invention in light of the above detailed description. The terms used in the following claims should not be construed to limit the invention to the specific embodiments disclosed in the specification and the claims. Rather, the scope of the invention is to be determined entirely by the following claims, which are to be construed in accordance with established doctrines of claim interpretation.

What is claimed is:

1. A method for communicating promotions, comprising:
activating an application on a wireless device;
transmitting a store identification to a promotion processing unit using the application, the store identification identifying one of a plurality of stores;
receiving and storing on the wireless device, in response to the transmitting, from the promotion processing unit, targeted promotions of goods and services, unique to a user of the wireless device, from a common chain of stores to which the one of a plurality of stores belong;
applying, in response to the transmitting, by the promotion processing unit, the targeted promotions to a point of sale in the one of a plurality of stores to be applied when the user of the wireless device checks out;
receiving and storing, on the wireless device, on-demand promotions of merchandises available in the one of the plurality of stores, the on-demand promotions include at least one of promotions specific to a duration or specific to a store location or a combination thereof, occurring in the one of the plurality of stores; and
transmitting, from the wireless device, the on-demand promotions to the processing promotion unit, at least a portion of the on-demand promotions to be applied to the point of sale in the one of the plurality of stores.

2. The method of claim 1 wherein the wireless device is at least one of a cellular phone, a personal digital assistant or a mobile handheld data processing device and wherein the promotion processing unit and the wireless device exchanges information via cellular network.

3. The method of claim 1 wherein the application is Wireless Application Protocol (WAP) based that also includes a customer loyalty program uniquely designed to interact specifically with the promotion processing unit, and is uploaded to the user's wireless device to receive and to transmit promotion information.

4. The method of claim 1 wherein the on-demand promotions are sent collectively as one list to the promotion processing unit.

5. The method of claim 1 wherein the on-demand promotions are sent individually to the promotion processing unit as each of the on-demand promotions are received on the user's wireless device.

6. The method of claim 1 wherein the plurality of stores further includes stores of different types and stores located in different geographical locations

7. The method of claim 1 wherein the targeted promotions and the on-demand promotions are associated with a customer loyalty program and further comprise at least one of a promotion, a discount, a sample offer, a customer survey, or a combination thereof for both products and services.

8. The method of claim 7 wherein the one of the plurality of different stores is a participant of the customer loyalty program.

9. The method of claim 1 further comprising:
receiving, on the wireless device, a user identification;
transmitting, from the wireless device, the user identification to the promotion processing unit, wherein the promotion processing unit associates the store identification, the user identification, and the on-demand promotions before the transmitting to the point of sale at the one of the plurality of stores.

10. The method of claim 9 wherein the promotion processing unit and the point of sale at the one of the plurality of stores are connected by at least one of a cellular network or world wide web (internet).

11. The method of claim 9 wherein the promotion processing unit and the point of sale at the one of the plurality of stores are connected by a promotion distribution unit that stores and controls flow of information between the promotion processing unit and the point of sale.

12. The method of claim 11 wherein the on-demand promotions may be related to in-store merchandises redeemable at the point of sale or promotions which are to be redeemed by the promotion processing unit.

13. The method of claim 1 wherein the on-demand promotions of the merchandises in the one of the plurality of stores are displayed on at least one of electronic displays in the store, exterior of packaging products or shelf displays near where products are displayed or a combination thereof.

14. The method of claim 1 further comprising:
storing, on the wireless device a shopping list of products and services created by the user;
transmitting, from the wireless device, items selected from the shopping list of products and services created by the user to the promotion processing unit to check for promotions on the items selected.

15. The method of claim 1 wherein a remaining portion of the on-demand promotion list not applied to the point of sale is to be fulfilled by the promotion processing unit and includes at least one of communicating with vendors for fulfillment of samples, sending email or text message reminders to the user, entering the user into contests, sending the user additional promotional offers, or a combination thereof.

16. The method of claim 1 wherein the promotion processing unit is further configured to communicate with database servers that contains customer loyalty program information and other promotional information related to the targeted promotions and the on-demand promotions.

17. The method of claim 1 wherein the targeted offers are determined specifically for each unique user based on the user's past purchasing pattern.

18. The method of claim 17 wherein the targeted offers may be different for different store identifications and each targeted offer is uniquely valid to the store location in which the store identification belongs.

19. A method for communicating promotions, comprising:
storing, on a promotion processing unit, on-demand promotions and targeted promotions redeemed at a plurality of different stores by a user;
analyzing, on the promotion processing unit, purchasing patterns based on the on-demand promotions and the targeted promotions redeemed by the user;
generating, on the promotion processing unit, in conjunction with at least one associated database servers, groups of new targeted promotions based the purchasing patterns of the user, each group of new targeted promotions to be unique to the user and to each of the plurality of different stores;
receiving, on the promotion processing unit, a store identification corresponding to one of the plurality of different store, from a wireless device belonging to the user; and
transmitting, a group of new targeted promotions, specific to the one of the plurality of different stores, from the promotion processing unit to the wireless device and to a point of sale in the one of the plurality of different stores so the group of new targeted promotions is redeemable by the user at checkout.

20. The method of claim 19 wherein the wireless device is at least one of a cellular phone, a personal digital assistant or a mobile handheld data processing device and wherein the promotion processing unit and the wireless device exchanges information via cellular network.

21. The method of claim 19 wherein a Wireless Application Protocol (WAP) based application that includes a customer loyalty program, uniquely designed to interact specifically with the promotion processing unit, is uploaded to the user's wireless device to receive and to transmit promotion information.

22. The method of claim 19 wherein the custom mobile application is activated on the wireless device prior to the wireless device transmitting the store identification to the promotion processing unit.

23. The method of claim 19 wherein the group of new targeted promotions are automatically transmitted from the promotion processing unit to the wireless device and the point of sale in the one of the plurality of different stores upon receiving the store identification from the wireless device.

24. The method of claim 19 further comprising,
receiving and storing, on-demand promotions of merchandises available in the one of the plurality of different stores, the on-demand promotions include at least one of promotions specific to a duration or specific to a store location or a combination thereof, for merchandise available in the one of the plurality of different stores.

25. The method of claim 24 wherein at least a portion of the on-demand promotions are transmitted to the promotion processing unit to be applied at the point of sale in the one of the plurality of different stores.

26. The method of claim 25 wherein the on-demand promotions are sent individually to the promotion processing unit as each of the on-demand promotions are received on the user's wireless device.

27. The method of claim 25 wherein the on-demand promotions are sent collectively as one list to the promotion processing unit.

28. The method of claim 19 wherein the plurality of different stores further includes stores of different types and stores located in different geographical locations

29. The method of claim 19 wherein the targeted promotions and the on-demand promotions are associated with a customer loyalty program and further comprise at least one of a promotion, a discount, a sample offer, a customer survey, or a combination thereof for both products and services.

30. The method of claim 29 wherein the one of the plurality of different stores is a participant of the customer loyalty program.

31. The method of claim 19 wherein the point of sale in the one of the plurality of stores and the promotion processing unit communicates via at least one of a cellular network or world wide web/internet.

32. The method of claim 31 wherein the point of sale in the one of the plurality of stores and the promotion processing unit are connected via a promotion distribution unit.

33. The method of claim 32 wherein the promotion distribution unit is physically located in the one of the plurality of store and electrically coupled to an electronic display displaying the in-store promotions.

34. The method of claim 19 further comprising
storing, on the wireless device before receiving the targeted promotions and the in-store promotions, a shopping list of products and services.

35. The method of claim 34 further comprising
transmitting, from the wireless device to the promotion processing unit, the shopping list of products and services for the promotion processing unit to identify the user preferences and the user purchasing patterns.

36. The method of claim 19 wherein the promotion processing unit is further configured to communicate with database servers that contains customer loyalty program information and other promotional information related to the targeted promotions and the in-store promotions.

37. A system to capture and distribute promotions, comprising:
a plurality of stores where goods and services are sold;
a wireless device configured to receive targeted promotions from a promotion processing unit, to receive inputs from a user, the user inputs include at least one of store identification, user identification, on-demand promotions, or a combination thereof, and to transmit the user inputs to a processing unit, wherein
the targeted promotions are specific to the user, based on past purchasing patterns of the user, and unique to each store identification transmitted from the wireless device;
the on-demand promotions are specific to goods and services available in the plurality of stores;
the promotion processing unit configured to,
transmit the targeted promotions, onto the wireless device and to a point of sale in one of the plurality of stores to which the store identification is associated, in response to receiving the store identification from the wireless device;
transmit the on-demand promotions to the point of sale in the one of the plurality of stores to which the store identification is associated; and
store and associate the user identification, the store identification, the targeted promotions, and the on-demand promotions.

38. The system of claim 37 wherein the wireless device is at least one of a cellular phone, a personal digital assistant or a mobile handheld data processing device and wherein the promotion processing unit and the wireless device exchanges information via cellular network.

39. The system of claim 37 wherein a Wireless Application Protocol (WAP) based application that includes a customer loyalty program, uniquely designed to interact specifically with the promotion processing unit, is uploaded to the user's wireless device to receive and to transmit the user inputs.

40. The system of claim 39 wherein the wireless device is further configured to store a shopping list of items created by the user from a website associated with each of the plurality of stores.

41. The system of claim 37 wherein the on-demand promotions include at least one of promotions specific to a duration or specific to a store location or a combination thereof, for merchandise available in the one of the plurality of stores.

42. The system of claim 37 wherein the on-demand promotions are collectively sent as one list to the promotion processing unit.

43. The system of claim 37 wherein the on-demand promotions are sent individually to the promotion processing unit as each of the on-demand promotions is received on the user's wireless device.

44. The system of claim 37 wherein the plurality of stores further include stores of different types and stores in different geographical locations.

45. The system of claim 37 wherein the targeted promotions and the on-demand promotions are associated with a customer loyalty program and further comprise at least one of a promotion, a discount, a sample offer, a customer survey, or a combination thereof for both products and services.

46. The system of claim 45 wherein the plurality of stores are participants of the customer loyalty program.

47. The system of claim 37 wherein the point of sale communicates with the promotion processing unit by at least one of a cellular network or a world wide web (internet).

48. The system of claim 47 wherein the point of sale and the promotion processing unit are connected via a promotion distribution unit in the one of the plurality of stores to which the store identification associates.

49. The system of claim 48 wherein the promotion distribution unit is configured to regulate information transfer between the promotion processing unit and the point of sale in the one store of the plurality of stores to which the store identification associates.

50. The system of claim 48 further comprises an electronic display configured to display the on-demand promotions and is coupled to the promotion distribution unit in the one of the plurality of stores to which the store identification associates to receive content and instructions from the promotion processing unit.

51. The system of claim 37 wherein the targeted promotions are automatically sent to both the point of sale and the wireless device after receiving the store identification from the wireless device.

52. The system of claim 37 wherein the promotion processing unit is further configured to communicate with database servers that contains customer loyalty program information and promotional information related to the targeted promotions and the on-demand promotions.

53. The system of claim 37 wherein the promotion processing unit is further configured to fulfill a portion of the on-demand promotions not redeemed at the point of sale that may include at least one of communicating with vendors for fulfillment of samples, sending email or text messages to the user, entering the user into contests, sending the user additional offers, or a combination thereof.

54. The system of claim 53 wherein the promotion processing unit is further configured to identify user preferences and user purchasing patterns based on the on-demand promotions and the targeted promotions that are redeemed at the point of sale and fulfilled by the promotion processing unit.

55. The system of claim 54 wherein the promotion processing unit provides the user preferences and the user purchasing patterns to another database server to generate new targeted promotions.

56. A system to capture and distribute promotions, comprising:
a plurality of stores where goods and services are sold;
a wireless device configured to receive targeted offers from a promotion processing unit, to receive inputs from a user, the user inputs include at least one of store identification, user identification or on-demand promotions or a combination thereof, and to transmit the user inputs to a processing unit, wherein,
the targeted promotions are specific to the user, based on past purchasing patterns of the user, and unique to each store identification transmitted from the wireless device;
the on-demand promotions are not valid in the plurality of stores;
a point of sale in each of the plurality of stores coupled to the promotion processing unit; and
the promotion processing unit configured to,
transmit the targeted promotions onto the wireless device, and to a point of sale corresponding to one of the plurality of stores to which the store identification associates where the targeted promotion are redeemed, in response to receiving the store identification from the wireless device,
redeem and fulfill the on-demand offers received from the wireless device.

57. The system of claim 56 wherein the wireless device is at least one of a cellular phone, a personal digital assistant or a mobile handheld data processing device and wherein the promotion processing unit and the wireless device exchanges information via cellular network.

58. The system of claim 56 wherein a Wireless Application Protocol (WAP) based application that includes a customer loyalty program, uniquely designed to interact specifically with the promotion processing unit, is uploaded to the user's wireless device to collect and to dispense information.

59. The system of claim 58 wherein the wireless device is further configured to store a shopping list of items created by the user from a website associated with each of the plurality of stores.

60. The system of claim 56 wherein the on-demand promotions are collectively sent as one list to the promotion processing unit.

61. The system of 56 wherein the on-demand promotions are sent individually to the promotion processing unit as each of the on-demand promotions is received on the user's wireless device.

62. The system of claim 56 wherein the plurality of stores further include stores of different types and stores in different geographical locations.

63. The system of claim 56 wherein the targeted promotions are associated with a customer loyalty program and further comprise at least one of a promotion, a discount, a sample offer, a customer survey, or a combination thereof for both products and services.

64. The system of claim 63 wherein the one of the plurality of stores is a participant of the customer loyalty program.

65. The system of claim 64 wherein the on-demand promotions are not a part of the customer loyalty program and the on-demand promotions cannot be redeemed in the plurality of stores.

66. The system of claim 56 wherein the point of sale and the promotion processing unit communicate via at least one of a cellular network or a world wide web (internet).

67. The system of claim 66 wherein the system further comprises a promotion distribution unit in each of the plurality of stores, the point of sale coupled to the promotion distribution unit, the promotion distribution unit controls the information flow between the point of sale and the promotion processing unit.

68. The system of claim 56 wherein the on-demand promotions include at least one of communicating with vendors for fulfillment of samples, sending email or text messages to the user, entering the user into contests, sending the user additional offers, or a combination thereof.

69. The system of claim 56 wherein the on-demand promotion is found on packaging exterior of goods and services available in the plurality of stores.

70. The system of claim 69 wherein the on-demand promotions include promotions redeemable with vendors that are not associated with the customer loyalty program participated by the plurality of stores.

71. The system of claim 56 wherein the promotion processing unit is further configured to store and associate the on-demand promotions with the user's identification.

72. The system of claim 71 wherein the promotion processing unit is further configured to identify user preferences to generate new on-demand promotions based on the user preferences and the user purchasing patterns, and to send the new targeted promotions to the user.

73. The system of claim 56 wherein the promotion processing unit is further configured to communicate with database servers that contains customer loyalty program information and other promotional information related to the targeted promotions and the in-store promotions.

74. A method for communicating promotions, comprising:
activating an application on a wireless device belonging to a user, the wireless device configured to receive user inputs including at least one of user identification, on-demand promotions, store identification or a combination thereof;
receiving and storing on the wireless device on-demand promotions the user entered from products or services in one of a plurality of stores, the on-demand promotions are not redeemable in the one of the plurality of stores;
transmitting the on-demand promotions from the wireless device to a promotion processing unit, the promotion processing unit connected to at least one vendor database server;
associating and storing, on the promotion processing unit, the on-demand promotions with a user identification;
redeeming the on-demand promotions for the user by the promotion processing unit.

75. The method of claim 74 wherein the wireless device is further configured to receive targeted promotions from the promotion processing unit.

76. The method of claim 75 further comprising:
transmitting a store identification corresponding to the one of the plurality of stores from the wireless device to the promotion processing unit;
transmitting targeted promotions from the promotion processing unit to both the wireless device and a point of sale in the one of the plurality of store, in response to the receiving of the store identification.

77. The method of claim 76 wherein the targeted offers are redeemable at the point of sale in the one of the plurality of stores.

78. The method of claim 77 wherein the targeted promotions are affiliated with a customer loyalty program in which the on-demand promotions are not associated.

79. The method of claim 77 wherein the targeted promotions further comprise at least one of a discount or rebate.

80. The method of claim 77 wherein the one of the plurality of stores is a participant of the customer loyalty program.

81. The method of claim 80 wherein the promotion processing unit identifies a user preference and a user purchasing pattern from targeted promotions redeemed at the point of sale by the user and communicates with a database that contains other promotional information related to the targeted promotions redeemed at the point of sale to generate new targeted promotions specific to the user.

82. The method of claim 74 wherein the wireless device is at least one of a cellular phone, a personal digital assistant, or a mobile handheld data processing device and wherein the promotion processing unit and the wireless device exchanges information via cellular network.

83. The method of claim 74 wherein the on-demand promotions are sent collectively as one list to the promotion processing unit.

84. The method of claim 74 wherein the on-demand promotions are sent individually to the promotion processing unit as each of the on-demand promotions are received on the user's wireless device.

85. The method of claim 74 wherein the plurality of stores further includes stores of different types and stores located in different geographical locations.

86. The method of claim 74 wherein the on-demand promotions further comprise at least one of a discount, a sample offer, a customer survey, or a combination thereof for both products and services.

87. The method of claim 74 wherein the promotion processing unit identifies a user preference and a user purchasing pattern from the on-demand promotions and communicates with a database that contains other promotional information related to the on-demand promotions to generate new on-demand promotions.
